(19) United States
(12) Patent Application Publication
(10) Pub. No.: US 2007/0061722 A1
(43) Pub. Date: Mar. 15, 2007

(54) Transparency learning aide skin for GUI-based applications

(75) Inventors: Curtis Duane Kronlund, Cottage Grove, MN (US); Scott Alan Moore, Rochester, MN (US); Gregory Allan Olson, Rochester, MN (US)

Correspondence Address: WOOD, HERRON & EVANS, L.L.P. (IBM), 2700 CAREW TOWER, 441 VINE STREET, CINCINNATI, OH, 45202, US

(73) Assignee: INTERNATIONAL BUSINESS MACHINES CORPORATION, ARMONK, NY (US)

(21) Appl. No.: 11/225,677

(22) Filed: Sep. 13, 2005

(51) Int. Cl. G06F 17/00

(52) U.S. Cl. 715/705

(57) ABSTRACT

The invention provides an apparatus, program product, and method that utilize a user interface, also referred to as a “transparency skin”, to allow users of software applications with new or unfamiliar user interfaces to learn such interfaces while still being productive in their work related tasks. A first user interface is displayed on a computer display. The first user interface includes a first control configured to perform a computer operation in response to user input directed thereto. A second user interface is overlaid over the first user interface, where at least a portion of the second user interface is at least semi-transparent such that at least a portion of the first user interface is visible while the second user interface is overlaid. The second user interface includes a second control configured to perform the computer operation in response to user input directed thereto. In connection with receiving user input directed to the second control in the second user interface the first control in the first user interface is highlighted to indicate how to initiate the computer operation using the first user interface.

### FIELD OF THE INVENTION

The present invention generally relates to user interfaces and, more particularly, to allowing a user to interact with one user interface while learning how to interact with another user interface.

### BACKGROUND OF THE INVENTION

With today's ever increasing screen-based input devices, end users are continually challenged by the need to learn new and/or different user interfaces. Over time and with continual use of a software application, users become more skilled in the application, building expertise, which leads to increased productivity when using that particular application. Vendors of software applications periodically release new versions of the applications with new features and modifications to the user interfaces. Similarly, enterprises may choose to integrate new products or software applications from different vendors. Whether these changes are to software applications running on a personal computer, PDA, cell phone or other electronic device, the challenge remains the same: How do users easily and productively adapt to these new interfaces as they are updated, changed, or replaced?

As an example, a business may be using a set of office software applications produced by Vendor 1. The company has made a decision to switch their office software applications to the Vendor 2 set of office software applications for business reasons.

Migrating from the set of Vendor 1 office software applications to those offered by Vendor 2 can involve a steep learning curve for end users. While the new software application may perform many of the same functions, the interfaces between the old and new software application are often different. The differences require users to learn the new interfaces before they can approach their former level of productivity. Similarly, when new versions of software applications are released, changes to the user interface often occur to reflect the additional functionality added to the software application as well as ease of use requests by the current user community. Moving to a new version of a software application with which the user is already familiar can be just as frustrating as learning a new piece of software, especially if there have been major changes to the interface between versions. Other examples include moving a software application to a new framework; using a software application on a personal computer with a PDA or Cell Phone; changing pieces of hardware, as in buying a new PDA or Cell Phone; etc.

End users have a number of choices available to them when attempting to learn a new user interface. First a user may simply learn the new interface on their own. The learning process may be accomplished by the end user using a brute force method of trying to interact with the new interface using the User's Manual, New Features Guide or Read Me files to assist them. While the user is accomplishing work related tasks, the productivity level of this user is often extremely low until the user becomes more familiar with the new interface, not to mention extremely frustrating to the user. The initial learning curves can be quite steep and the productivity levels can suffer for quite a while using this method.

Some software applications come with demonstrations or tutorials that users can utilize to learn the new software application. These have benefits as the user can learn the new interface at their own pace. The drawback to the process is that the demonstrations or tutorials usually do not cover all of the functionality of the software application, and the material covered may or may not pertain to the task that the user is trying to perform. Again productivity may suffer as the users traverse the demonstrations and tutorials and then try to apply those concepts to the actual work related task that needs to be performed.

Likewise, a user could find a coworker that may be familiar with the new interface to assist them. This process allows the user to avoid spending time on problems that may not apply to their tasks and get actual work related tasks performed. The drawbacks to relying on this method are that first the user needs to find someone who is already familiar with the interface, which can be very challenging if this is a new release of a software package. Also, the productivity of two workers is affected when two people are working on the same task during the learning process.

Many software application vendors will offer classes that teach new users how to use the software application. These courses can range anywhere from an afternoon to as much as a week depending on the complexity of the software application. The classes are typically much more comprehensive than the demonstrations or tutorials that are delivered with the software application. The drawback is again loss of productivity for the end user. The user cannot be producing while they are attending a class to learn how to use the new software application. Even after the class, there still may be a rather steep learning curve as the end user begins to apply what they learned in the class to the actual work related tasks that they need to perform.

Each of the above mentioned solutions have one common problem, that problem being that each of the solutions requires time, which typically results in the loss of productivity. While the user is spending time learning how the new interfaces work, the user is not accomplishing their work related tasks. Accordingly, there is a need in the art for an improved way of enabling end users to learn the new interfaces with reduced impact on productivity.

### SUMMARY OF THE INVENTION

The invention addresses these and other problems associated with the prior art and existing solutions by providing an apparatus, program product, and method, that utilize a user interface, hereinafter referred to as a “transparency skin”, to allow users of software applications with new or unfamiliar user interfaces to learn such interfaces while still being productive in their work related tasks. In many instances, users can learn at their own pace with the aide of the transparency skins with reduced time loss as compared to other solutions.

When the transparency skin is activated for a software application, the software application initially displays a first user interface on a computer display, where the first user interface includes a first control configured to perform a computer operation in response to a user input directed thereto. A second user interface for the software application is overlaid over the first user interface and at least a portion of the second user interface is at least semi-transparent such that at least a portion of the first user interface is visible while the second user interface is overlaid. The second user interface includes a second control configured to perform the computer operation in response to a user input directed thereto. The first control in the first user interface is then highlighted after receiving the user input directed to the second control in the second user interface indicating how to initiate the computer operation using the first user interface.

From the foregoing disclosure and the following more detailed description of various illustrated embodiments it will be apparent to those skilled in the art that the present invention provides a significant advance in self paced learning aids for software applications executing on electronic devices. Particularly significant in this regard is the potential the invention affords for providing this learning aid to be used on any electronic device, including devices such as PDAs and cellular telephones. Additional features and advantages of various embodiments will be better understood in view of the detailed description provided below.

### BRIEF DESCRIPTION OF THE DRAWINGS

These and further features of the present invention will be apparent with reference to the following description and drawings wherein:

FIG. 1A is a perspective view of a computer suitable for utilizing a transparency skin consistent with the invention;

FIG. 1B is a perspective view of a Personal Data Assistance (“PDA”) suitable for utilizing a transparency skin consistent with the invention;

FIG. 1C is a perspective view of a Cellular or Mobile Telephone suitable for utilizing a transparency skin consistent with the invention;

FIG. 2 is a block diagram of an exemplary hardware and software environment for any of the devices illustrated in Figures 1A-1C, within which is implemented a transparency skin consistent with the invention;

FIGS. 3 and 4 are exemplary representations of first and second user interfaces for use in illustrating the use of a transparency skin consistent with the invention;

FIG. 5 is a flowchart illustrating the program flow of an exemplary sequence of operations performed by the software application interacting with the transparency skin of FIG. 4;

FIGS. 6A, 6B, and 6C are block diagrams of an exemplary display illustrating a software application window and a transparency skin interacting with the software application window in connection with the program flow of FIG. 5;

FIG. 7 is a flowchart illustrating an alternate program flow of an exemplary sequence of operations performed by the software application interacting with the transparency skin of FIG. 4; and

FIGS. 8A, 8B, and 8C are block diagrams of an exemplary display illustrating a software application window and a transparency skin interacting with the software application window in connection with the program flow of FIG. 7.

It should be understood that the appended drawings are not necessarily to scale, presenting a somewhat simplified representation of various preferred features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION

The embodiments described hereinafter utilize a unique transparency skin, or user interface that is capable of being displayed over a second user interface. The first and second user interfaces are generally associated with a programmatic application that displays information to a user and then requires the user to supply input based on the display. Linking the first and second interfaces to the application can be utilized as a learning tool to teach existing users of a software application how to interact with a new user interface. Situations where this might be applicable are when a new version of a software application becomes available or when a new piece of hardware is purchased which contains an updated interface.

The discussion hereinafter will focus on two particular implementations of the invention used as a method of training a user how to interact with an unfamiliar user interface. There is an assumption made that the user is familiar with either an older version of the user interface or that the user interfaces are interfaces for two different software applications of which the user is familiar with one of the applications. The invention is not limited, however, to use as a method for training users to interact with a new user interface. Other uses and applications of overlaying a transparent version of a user interface over second user interface will be apparent to those skilled in the art given the benefit of this disclosure.

The transparency skins of the invention when used as a learning aide allow the user of a software application to interact with an older version of the user interface with which the user has some familiarity. A user of a software application can be confronted with new user interfaces when new versions of the software application are released. They may be confronted with new user interfaces if the software application is provided by an alternate vendor whose product has the similar functionality, but a different user interface. In either of these situations, the user needs to learn the new interface while still being able to complete work related tasks without a significant loss in time.

In one embodiment of the invention the old user interface is displayed with the new software application. After the user interacts with the software application using the old user interface, a transparency skin of the new user interface is overlaid on the old user interface and the same interaction is graphically displayed on the new user interface, showing the user the proper sequence of steps to perform the same function with the new user interface. The transparency skin is then removed or hidden and the user can then perform the next interaction with the software application.

In an alternate embodiment of the invention, the software application displays the new user interface and a transparency skin of the old user interface is overlaid on the new user interface. The user again interacts with the old user interface. The transparency skin is then removed or hidden and the same interaction is graphically displayed on the new user interface, showing the user the proper sequence of steps to perform the same function on the new user interface. The transparency skin of the old user interface is again overlaid on the new user interface awaiting the next interaction from the user.

### HARDWARE AND SOFTWARE ENVIRONMENT

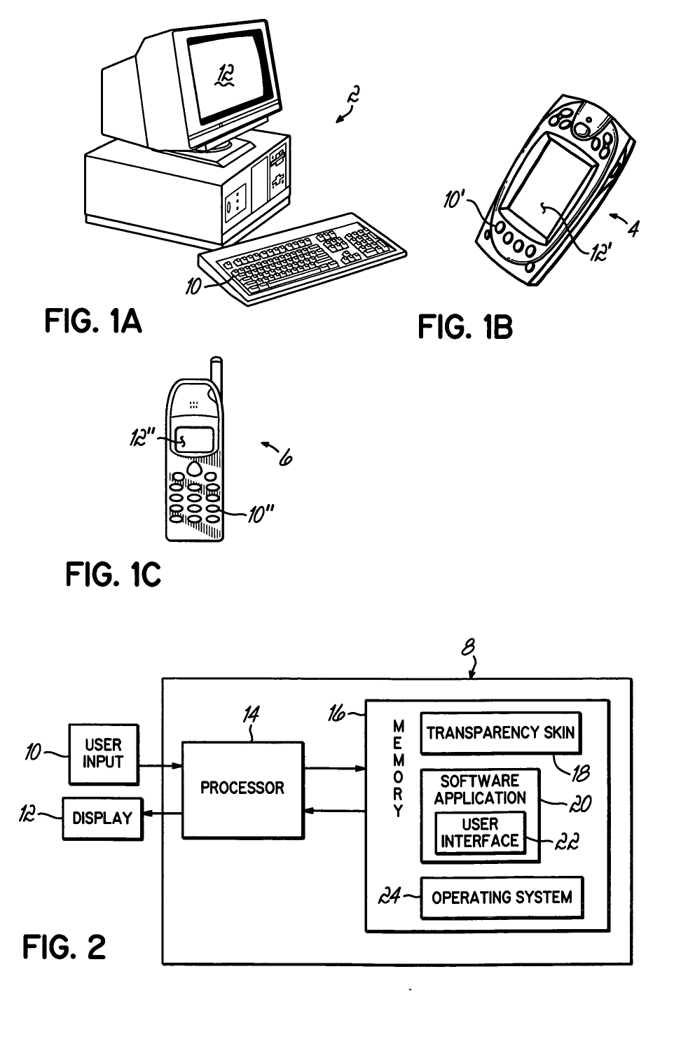

Turning to the drawings, wherein like numbers denote like parts throughout the several views, FIG. 2 illustrates an exemplary hardware and software environment for an apparatus 8 consistent with the invention. For the purposes of the invention, apparatus 8 may represent any programmable device with a user input 10, a processor 14 with a memory 16, and a display 12 such as a computer 2 depicted in FIG. 1A, a PDA 4 as depicted in FIG. 1B, or a cellular telephone 6 as depicted in FIG. 1C. Apparatus 8 will hereinafter be referred to as a “computer” although it should be appreciated that the term “apparatus” may also include other suitable programmable electronic devices, in addition to those mentioned above, that are consistent with the invention.

Computer 8 typically includes at least one processor 14 coupled to a memory 16. Processor 14 may represent one or more processors (e.g. microprocessors), and memory 16 may represent the random access memory (RAM) devices comprising the main storage of computer 8, as well as any supplemental levels of memory, e.g., cache memories, non-volatile or backup memories (e.g. programmable or flash memories), read-only memories, etc. In addition, memory 16 may be considered to include memory storage physically located elsewhere in computer 8, e.g., any cache memory in a processor 14, as well as any storage capacity used as a virtual memory, e.g., as stored on a mass storage device (not shown) or another computer coupled to computer 8 via a network (not shown).

Computer 8 also typically receives a number of inputs and outputs for communicating information externally. For interface with a user or operator, computer 8 typically includes one or more user input devices 10 (e.g., a keyboard, a mouse, a trackball, a joystick, a touchpad, a keypad, a stylus, and/or a microphone, among others). Computer 8 also includes a display 12 (e.g., a CRT monitor, an LCD display panel, and/or a speaker, among others). As shown in FIG. 1B and 1C, suitable input devices 10′ and 10″, and displays 12′ and 12″ are likewise provided on PDA and cell phone implementations of computer 8.

Computer 8 operates under the control of an operating system 24, and executes or otherwise relies upon various computer software applications, components, programs, objects, modules, data structures, etc. (e.g. software application 20, software application user interface 22, and transparency skin 18, among others). Moreover, various applications, components, programs, objects, modules, etc. may also execute on one or more processors in another computer coupled to computer 8 via a network (not shown), e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to tangible, recordable type media such as volatile and non-volatile memory devices, floppy and other removable disks, hard disk drives, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. For example the controls 32 and 42 referred to in the following explanation may include and be referred to as items such as buttons, radio buttons, knobs, slider bars, hypertext, pull down menus, tool bars and the like.

Those skilled in the art will recognize that the exemplary environments illustrated in FIGS. 1A, 1B, 1C, and 2 are not intended to limit the present invention. Indeed, those skilled in the art will recognize that other alternative hardware and/or software environments may be used without departing from the scope of the invention.

### TRANSPARENCY SKIN AS A TEACHING AIDE

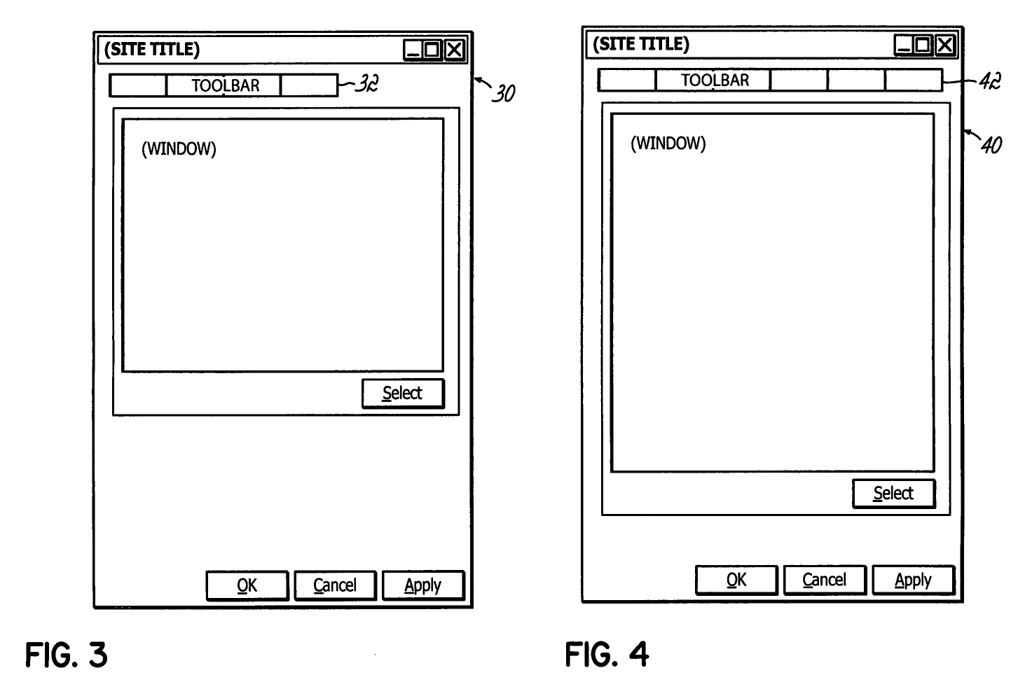

In an embodiment of the Transparency Skin being used as a Teaching Aide, the transparency skin 18 can be used to teach the user of a software application how to use that application when the user interface 22 for the software application 20 has changed. FIGS. 3 and 4 show exemplary representations of an old user interface 30 and a new user interface 40. Changes to a user interface may occur when new versions of applications are released with new functionality requiring changes to the user interface. Changes also occur based on recommendations from a user base that is utilizing a particular application. This embodiment can also be used to as a Teaching Aide to teach the user of one application how to use a similar application produced by a different vendor.

An example of where the embodiment would be used is when the user is familiar with a word processing system that is produced by Vendor 1 and that word processing system is being replaced by a word processing system produced by Vendor 2. Vendor 2's word processing system has a different user interface. The transparency skin 18 can be used with any software application that has a new user interface 40. The transparency skin 18 can assist in teaching the user how to use the software application with the new user interface 40 by allowing the user to interact with the older user interface 30 and then graphically mapping one or more controls 32 from the old user interface 30 to the corresponding controls 42 from the new user interface 40. For example, with the word processing system discussed above, the word processor from Vendor 1 may have a button that is used to change document margins. The word processor from Vendor 2 may require a user to select a tab for margins on the page setup screen, which is accessed from a pull down menu. The user would select the button on the old user interface 30 and then a transparency skin 18 of the new user interface 40 would be displayed. A graphical representation of the process of selecting page setup from the pull down menu and then selecting the margins tab would occur.

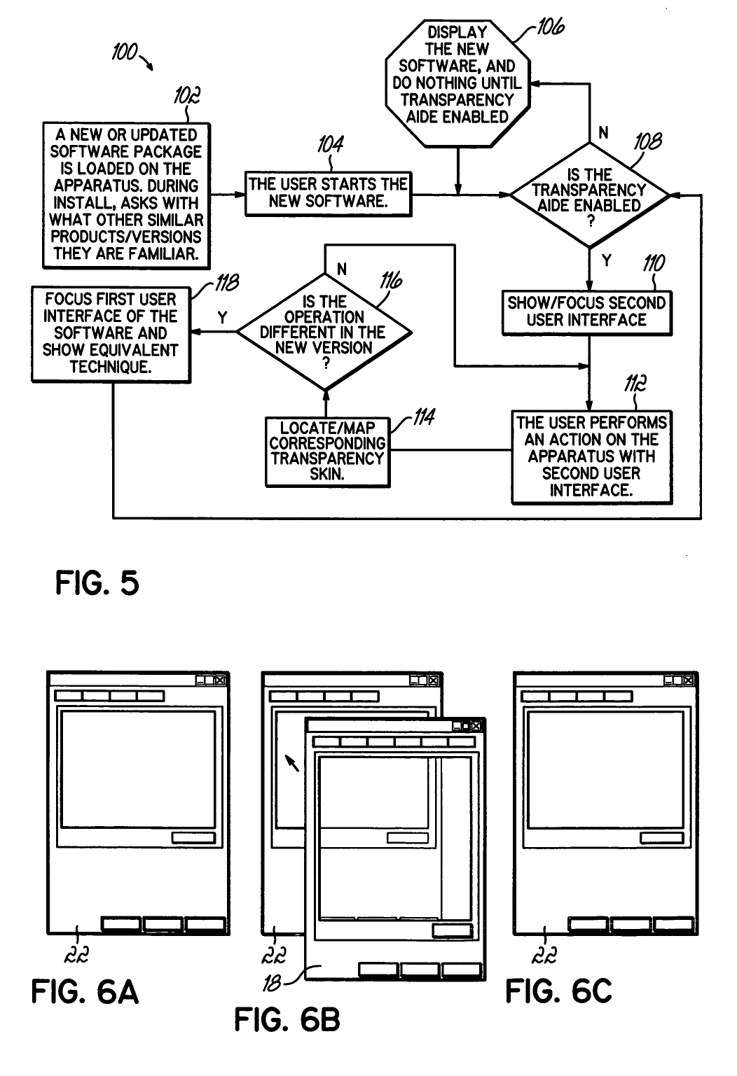

The teaching embodiment discussed above can be better understood by referring now to the process depicted in flowchart 100 in FIG. 5. In block 102, a new or updated software application having a new user interface 40 is loaded onto the computer 8. In block 102, during the installation, the installation procedure queries the computer 8 or queries the installer to determine whether other similar software applications or earlier versions of the same application are being used. Similarly the user may also be queried during the installation procedure as to which related software applications that he or she is used to using. In block 104, after the user starts the new software application, the user is prompted in block 108 to determine if he or she would like to enable the transparency aide. If the user decides to not use the transparency aide during a particular session, the user interface 22 for the software application 20 will be the new user interface 40. In block 106, the software application 20 operates in this mode until the transparency aide is enabled.

In block 108, if the user decides to enable the transparency aide, the software application 20 displays the old version of the user interface 30 with which the user is familiar on the display 12. As mentioned previously, this interface may be the interface from an earlier version of the software application or it may be the interface from a competing product. In block 110 the software application 20 then focuses user input 10 to the old version of the user interface 30. In block 112 the user input 10 is provided to the software application 20 based on the old user interface 30. In block 114 the software application 20 then locates and maps the control 32 from the old user interface 30 to the corresponding control 42 on the new user interface 40.

In order to map controls between user interfaces, a relationship between the old user interface 30 and the new user interface 40 needs to be established. This relationship may be in the form of a look up table or a database that contains the old control 32 information and the corresponding new sequence of controls 42 for the new user interface 40.

In block 116, if the method of user input 10 between the control 32 from the old user interface 30 and the corresponding control 42 for the new user interface 40 differs, then in block 118 a transparency skin 18 of the new user interface 40 is overlaid on the old version of the user interface 30 on the display 12. In block 118, the equivalent user input 10 commands are then graphically displayed or highlighted for the new user interface 40 on the display 12 to teach the user the equivalent technique. The graphical display may be an animation sequence of the corresponding buttons, menus, or other controls on the new user interface 40 needed to perform the operation. The graphical display may be a graphical representation of a keyboard showing the proper sequence of key strokes the user must use for the new user interface 40. The graphical display may simply highlight areas on the new user interface 40 that the user would need to select. The transparency skin 18 of the new user interface 40 is then removed from the display 12 and software application 20 is ready for the next user input 10.

FIGS. 6A, 6B, and 6C illustrate what a user might see on the display 12 during the process described in connection with FIG. 5. As illustrated in FIG. 6A, the user might initially see the old user interface 30 on the display 12. The user interacts with a control 32 on the old user interface 30 and then as illustrated in FIG. 6B, the user might see a transparency skin 18 of the new user interface 40 overlaid on the old user interface 30. When the transparency skin 18 is overlaid on the old user interface 30, some or all of the old user interface 30 may still be visible. In many embodiments, the transparency skin 18 may be considered to be analogous to a sheet of transparency film that would be placed on another sheet of paper. The images on the paper would be visible through the transparency film except in those areas where something is printed on the transparency film. As in the transparency film analogy, the user is still able to see the old user interface 30 through the overlaid transparency skin 18 of the new user interface 40 due to the at least semi-transparent nature of the transparency skin 18. As such, at least semi-transparent refers to being able to see at least a portion of the user interface that is under the transparency skin 18 through the transparency skin 18. Of note, visible portions of the transparency skin 18 need not be completely opaque, but may be partially transparent such that the underlying user interface is still somewhat visible through the visible portions of the transparency skin 18.

The control 32 that the user interacted with on the old user interface 30 corresponds to a particular action that the user wanted to perform with the software application. The software application would then determine the corresponding control or controls using a mapping technique as discussed above and then the new control or controls 42 may be displayed or highlighted as discussed above on the new user interface 40. Once the new control or controls 42 have been displayed or highlighted, as illustrated in FIG. 6C, the transparency skin 18 may then be removed or hidden from the display 12 and the user might again view the old user interface 30 on the display 12 waiting for the next interaction.

The transparency skin 18 can be displayed and removed from the display in a number of different manners. The transparency skin 18 may be graphically faded in and faded out as it is displayed and removed from the display. It maybe scrolled on and off of the computer screen from any combination of the top, bottom, left or right of the screen. It may just simply appear or disappear. The approach used to display the transparency skin 18 and to remove the transparency skin 18 from the display may be a matter of personal taste and would not necessarily affect the underlying principles of the invention.

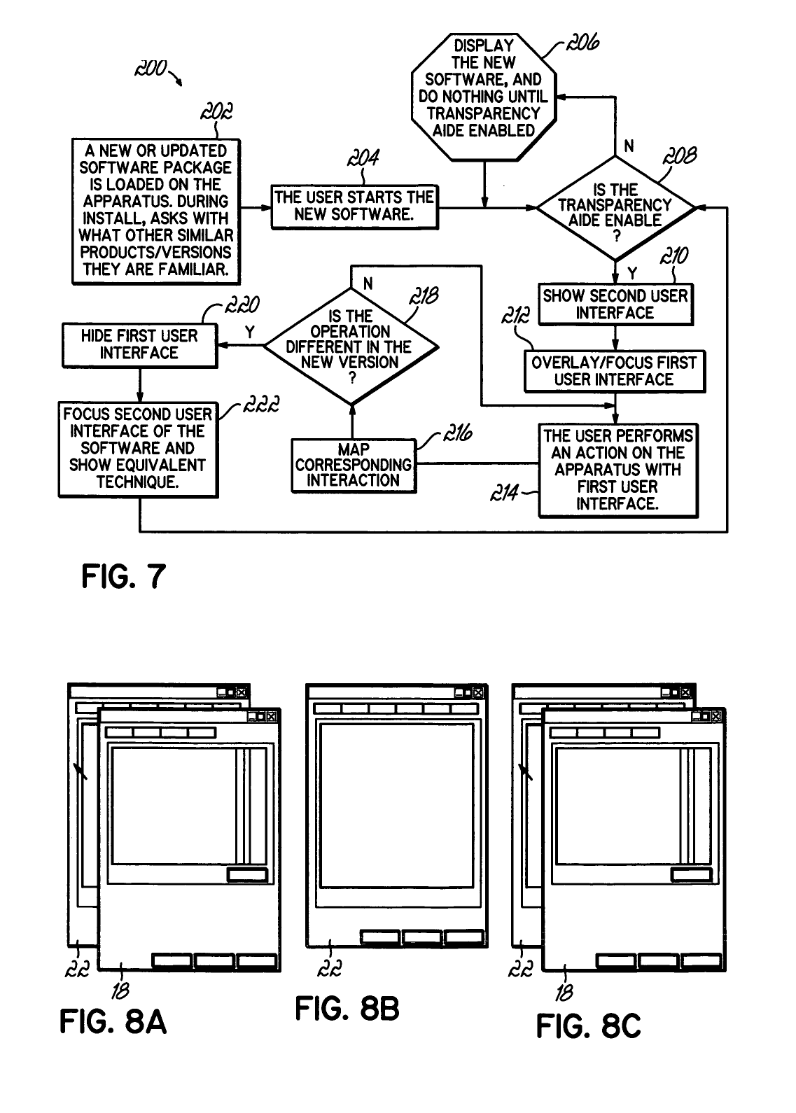

In an alternate embodiment of using the transparency skin 18 as a teaching tool, both user interfaces may be shown to the user as the user is interacting with the old user interface 30. Referring now to the process of this embodiment depicted in flowchart 200 in FIG. 7, in block 202, a new or updated software package having a new user interface 40 is loaded onto the computer 8. In block 202, during the installation, the installation procedure queries the computer 8 or queries the installer to determine whether other similar products or earlier versions of the same product are being used. In block 202, similarly the user may also be queried during the installation procedure as to which related software products that he or she is used to using. In block 204, once the user starts the new software package, in block 208 the user is prompted to determine if he or she would like to enable the transparency aide. If the user decides to not use the transparency aide during a particular session, the user interface 22 for the software application 20 will be the new user interface 40. In block 206, the software application 20 operates in this mode until the transparency aide is enabled.

In block 208, if the user decides to enable the transparency aide, in block 210 the software application 20 displays the new user interface 40 with which the user is unfamiliar on the display 12. In block 212, the software application 20 then overlays a transparency skin 18 of the old user interface 30 over the new user interface on the display 12. In block 212, the software application 20 sets the input focus to the transparency skin 18 of the old user interface 30. In block 214, the user interacts with the older user interface 30. In block 216, the control 32 selected from the old user interface 30 is then mapped to the corresponding control or controls 42 on the new user interface. In block 218, if the operation is different on the new user interface 40, then in block 220, the transparency skin 18 of the old user interface 30 is removed or hidden and in block 222, the software application 20 graphically displays the equivalent technique on the new user interface 40. In block 222, when the new technique has been demonstrated to the user, then in block 212 the transparency skin 18 of the old user interface 30 is again overlaid on the new user interface 40 on the display 12.

FIGS. 8A, 8B, and 8C illustrate what the user might see on the display 12 during the process described in connection with FIG. 7. As illustrated in FIG. 8A, the user might initially sees a transparency skin 18 of the old user interface 30 overlaid on the new user interface 40 on the display. The user is still able to see the new user interface 40 through the overlaid transparency skin 18 of the old user interface 30 due to the at least semi-transparent nature of the transparency skin 18. The user interacts with the transparency skin 18 of the old user interface 30 and then as illustrated in FIG. 8B, the transparency skin 18 is removed or hidden from the display 12. The same command sequence may then be demonstrated on the new user interface 40. As illustrated in FIG. 8C, the transparency skin 18 of the old user interface 30 may again be overlaid on the new user interface 40 on the display 12, waiting for the next interaction.

From the forgoing disclosure and detailed description of certain illustrated embodiments, it will be apparent that various modifications, additions, and other alternative embodiments are possible without departing from the true scope and spirit of the present invention. For example, it will be apparent to those skilled in the art, given the benefit of the present disclosure, that the transparency skin can have many different applications in the area of computer based instruction alone. The embodiments that were discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer-implemented method for interacting with a software application comprising:
displaying a first user interface on a computer display, wherein the first user interface includes a first control configured to perform a computer operation in response to user input directed thereto;
overlaying a second user interface for the software application over the first user interface, wherein at least a portion of the second user interface is at least semi-transparent such that at least a portion of the first user interface is visible while the second user interface is overlaid, and wherein the second user interface includes a second control configured to perform the computer operation in response to a user input directed thereto; and
performing the computer operation in response to user input directed to the second control in the second user interface.

2. The method of claim 1 further comprising:
highlighting the first control in the first user interface after receiving the user input directed to the second control in the second user interface to indicate how to initiate the computer operation using the first user interface.

3. The method of claim 2 further comprising:
hiding the second user interface while indicating how to initiate the computer operation using the first user interface.

4. The method of claim 2 further comprising:
mapping the second control in the second user interface to the first control in the first user interface.

5. The method of claim 2 wherein the first user interface is an interface that is new to the user and the second user interface is an interface that is familiar to the user.

6. The method of claim 5 wherein the second user interface is associated with an earlier version of a computer software application than the first user interface.

7. The method of claim 5 wherein the first user interface is associated with a different computer software application than the second user interface.

8. The method of claim 7 wherein the computer software applications for the first and second user interfaces are produced by different entities.

9. The method of claim 1 further comprising:
highlighting the second control in the second user interface after receiving the user input directed to the first control in the first user interface to indicate how to initiate the computer operation using the second user interface.

10. The method of claim 9 further comprising:
mapping the first control in the first user interface to the second control in the second user interface.

11. The method of claim 9 wherein the second user interface is an interface that is new to the user and the first user interface is an interface that is familiar to the user.

12. The method of claim 11 wherein the first user interface is associated with an earlier version of a computer software application than the second user interface.

13. The method of claim 11 wherein the first user interface is associated with a different computer software application than the second user interface.

14. The method of claim 13 wherein the computer software applications for the first and second user interfaces are produced by different entities.

15. The method of claim 1 wherein all of the second user interface is at least semi-transparent.

16. The method of claim 1 wherein a portion of the first user interface is visible through the portion of the second user interface.

17. An apparatus comprising:
a memory; and
program code, resident in the memory, the program code configured to display a first user interface on a computer display, wherein the first user interface includes a first control configured to perform a computer operation in response to user input directed thereto, to overlay a second user interface over the first user interface, wherein at least a portion of the second user interface is at least semi-transparent such that at least a portion of the first user interface is visible while the second user interface is overlaid, and wherein the second user interface includes a second control configured to perform the computer operation in response to user input directed thereto, and to perform the computer operation in response to user input directed to the second control in the second user interface.

18. The apparatus of claim 17 wherein the program code is further-configured to highlight the first control in the first user interface after receiving the user input directed to the second control in the second user interface to indicate how to initiate the computer operation using the first user interface.

19. The apparatus of claim 18 wherein the program code is further configured to hide the second user interface while indicating the user-initiated operation on the first user interface.

20. The apparatus of claim 18 wherein the program code is further configured to map the second control in the second user interface to the first control in the first user interface.

21. The apparatus of claim 18 wherein the first user interface is an interface that is new to the user and the second user interface is an interface that is familiar to the user.

22. A program product, comprising:
a program code configured to display a first user interface on a computer display, wherein the first user interface includes a first control configured to perform a computer operation in response to user input directed thereto, to overlay a second user interface over the first user interface, wherein at least a portion of the second user interface is at least semi-transparent such that at least a portion of the first user interface is visible while the second user interface is overlaid, and wherein the second user interface includes a second control configured to perform the computer operation in response to user input directed thereto, and to perform the computer operation in response to user input directed to the second control in the second user interface; and
a computer readable signal bearing medium bearing the program code.

23. The program product of claim 22 wherein the program code is further configured to highlight the first control in the first user interface after receiving the user input directed to the second control in the second user interface to indicate how to initiate the computer operation using the first user interface.

24. The program product of claim 22 wherein the program code is further configured to map the second control in the second user interface to the first control in the first user interface.

25. The program product of claim 22 wherein the first user interface is an interface that is new to the user and the second user interface is an interface that is familiar to the user.
